(19) United States
(12) Patent Application Publication
(10) Pub. No.: US 2011/0076376 A1
(43) Pub. Date: Mar. 31, 2011

(54) NATURAL ANTIOXIDANT COMPOSITION FOR MEAT PRODUCTS PRODUCED FROM PHENOLIC EXTRACTS OF MONOFLORAL HONEYS, AND METHOD FOR OBTAINING THE SAME

(76) Inventor: Gloria Montenegro Rizzardini, Santiago (CL)

(21) Appl. No.: 12/936,829

(22) PCT Filed: Apr. 7, 2009
(86) PCT No.: PCT/ES09/00187

§ 371 Date: Nov. 30, 2010

(30) Foreign Application Priority Data
Apr. 7, 2008 (CL) 1000-2008

(51) Int. Cl. A23B 4/20; A23L 3/3463

(52) U.S. Cl. 426/542; 426/429

(57) ABSTRACT

Natural antioxidant composition for meat products, characterized in that it is prepared from phenolic extracts of monofloral honeys that act independently as antioxidants.

The present application is addressed to an extract of pure phenolic compounds from quillay honey. Specifically, it is described a method to generate an extract, without the use of ethylic ether, and resuspending the final extract in ethanol, so as to avoid the participation of solvents harmful for human being (ether and methanol). Ethanol is an alcohol metabolized by mammals liver, therefore this new extract could be added directly to food or pharmaceutical products consumed by humans.

### BACKGROUNDS OF THE INVENTION

Currently there is a growing demand for foods that are healthy, from natural origin, and also make some contribution to maintaining or improving the health of those who consume them. Foods that meet these requirements are known as functional foods.

Antioxidants are among the substances most required in functional foods. These are molecules that act as electrons donors, and thus may stabilize and inactivate other molecules known as free radicals, which are characterized by the absence of an electron in its structure, thereby making them highly reactive with any molecule that can donate to them that electron. In the human organism, as result of metabolism, free radicals are constantly generated, therefore are needed antioxidants that stabilize and inactivate them, thus avoiding the damage that these cause when they react with biologically important molecules, such as nucleic acids (DNA and ARN) and fatty acids constituent of membranes and proteins. When antioxidants deliver an electron, they turn into a weak free radical or a one with very low reactivity as, thanks to their structure, their electrons may move easily among the molecular orbitals, which makes the resulting molecule is much more stable.

We may classify antioxidants in two main groups: enzymatic antioxidants and non-enzymatic antioxidants. Within the first group are found the antioxidant enzymes, which are made by cells, act at intracellular level and are not consumed as they react with free radicals. The most important are catalase, glutathione peroxidase and superoxide dismutase. These operate either by avoiding the formation of free radicals from other molecules as well as by transforming the existing free radicals into molecules less harmful for the organism, before they react with important molecules. Their efficiency depends on the presence of some metals, as Fe, Cu, Mg, Zn or Se, and for its importance in the function of these enzymes are called antioxidant metals.

The non-enzymatic antioxidants, in turn, can be of endogenous origin, such as glutathione, urate, ubiquinol and some plasmatic proteins, or from exogenous origin, and among them are found all those compounds with antioxidant capacity that are obtained from the foods, such as carotenoid pigments, vitamins A, C and E, phenolic compounds and synthetic chemicals. These act both at intracellular level as at extracellular level, and on the contrary to the antioxidant enzymes, are consumed as they react with free radicals and must be constantly replenished. The ones of endogenous origin are synthesized again by the cells, while the exogenous ones must be ingested with the diet.

Dietary antioxidants are substances present in foods that significantly reduce the effects of free radicals (reactive species of oxygen or nitrogen) over the normal physiological functions in humans (Food and Nutrition Board, 1998). The major dietary antioxidants are the carotenoid pigments, vitamins A, C and E, phenolic compounds and the synthetic chemicals. Excluding the chemical synthetic antioxidants for obvious reasons, dietary antioxidants come mainly from vegetal foods such as fruits, vegetables, cereals, seeds, vegetal oils, juices, drinks like tea and wine, and apicultural products like honey and pollen.

The antioxidant defenses in our organism are fundamental to preserve good health. Consumption of foods from vegetal origin has been associated to a lower incidence and mortality of diverse diseases (Jacob and Burn, 1996; Hughes and Ong, 1998). The protection that these provide against cardiovascular or degenerative diseases as cancer has been attributed to their high content of antioxidants (Hertog et al, 1993a). Currently, there is extensive scientific evidence showing that the origin of diseases as arteriosclerosis and cancer, complications of pathologies like arthritis, diabetes and dementias, and the biological process of aging, is associated to oxidative damage, and are becoming better understood the mechanisms leading to the development of diseases starting from oxidative damage caused to biological molecules by the free radicals

Despite this common denomination, there are differences between the various dietary antioxidants, both in terms of their chemical behavior as in their biological properties. Some of these antioxidants, like vitamins C and E, carotenoids and Se, are well known, while others are novel and their properties have begun to be studied only in the last 2 decades, such as the case of phenolic compounds or polyphenols. However, still do not know for sure which of the antioxidant components of foods from vegatal origin in the diet is or are responsible for the protective effect against oxidative damage, although it is assumed that this task does not reside in one or a few substances, but in the joint action of several of them.

Phenolic compounds or polyphenols are a large family of compounds elaborated by plants as defense against the oxidative stress caused by abiotic factors, as UV radiation, and which are therefore found in many foods of vegetal origin, such as the berries, tea, wine and apicultural products (Ferreres et al., 1991; Hertog et al., 1993b; Tomás-Barberán et al., 1993; Simonetti et al, 1997; Sánchez-Moreno et al., 1999a, b; Kahkonen et al., 2001; Miranda-Rottmann et al, 2002). The main polyphenols present in our diet are phenolic acids, flavonoids, and pigments as anthocyanins and tannins. A particularly interesting group are the flavonoids, from which already have more than 4,000 described, having some of them an antioxidant capacity even higher than the vitamins A and E (Kinsella et al, 1993; Dugas et al., 2000).

Numerous beneficial effects for health are attributed to polyphenols (Diplock, 1991). In addition to their known antioxidant capacities, it has been reported that dietary polyphenols delay the aging and the cell death, they reduce the generation of the superoxide radical in cells; avoid the damage on genetic material and proteins, thus contributing to it's stability; increase the activity of detoxifying enzymes of toxins or drugs of liver; and reduce the risk of heart diseases and cancer (Reddy and Lokesh, 1992; Middleton et al, 2000; Ferguson 2001; Lu et al, 2001; Fahey and Stephenson, 2002; Ha et al., 2003; Schwarz and Roots 2003; Ueda et al, 2003; Pfeffer et al, 2003). Particularly, it has been described that, among others, several of the phenolic compounds and flavonoids found in honey, show important biological activities with a potential pharmaceutical or pharmacological use (Jeffrey & Echazarreta, 1996; Wandan, 1998). It has also been proposed their possible use as markers of honey floral origin. Thus, for example, honeys whose botanic origin comes from species of the genus Citrus present the hesperetin flavanone (Ferreres et al, 1993), which might be a very good indicator of the origin of that honey. The kaempferol flavonol is always present in rosemary honeys (Gil et al, 1995; Ferreres et al, 1998), and the abscisic and ellagic acids in honeys coming from nectars from plants of the genus Erica (Ferreres et al, 1996). Flavonoids myricetin, tricetin and luteolin have been suggested as markers of monofloral honeys from plants of the genus Eucalyptus (Martos et al, 2000a, b) in Australia, and the homogentisic acid has been proposed as marker for the monofloral honeys from Arbutus unedo in Italy (Cabras et al., 1999).

Therefore, the phenolic compounds and flavonoids present potentialities that have made interesting to investigate, qualitative and quantitatively, about their presence in Chilean honeys. For example, it has been isolated phenolic fractions of New Zealander monofloral honeys, originated from species of the Myrtaceae family, which have shown antibacterial activities (Russell et al, 1990; Weston et al, 2000); it needs to be highlighted that the species of the Myrtaceae family are among the most important sources of nectar for honey elaboration in Chile, being most of them native or endemic (Montenegro, 1992; Montenegro, 2000; Montenegro et al., 2003; Ramirez and Montenegro, 2004; Montenegro et al., 2005; Pizarro and Montenegro, 2006).

The composition and concentration of flavonoids and other phenolic compounds in honeys have shown to be highly variable, from very low levels up to 2400 mg/100 gr concentrations (Martos et al., 1997), following in some cases similar profiles to those found in some propolis from the same beehives. A new flavonoid, myricetin 3,7,4′,5′-etertetrametilic, was detected in honeys and propolis from Tunisia (Martos et al., 1997). In Chile, works on the chemical composition of flavonoids present in propolis have allowed to study their chemical profiles and to find new lignans type compounds, among others (Valcic et al, 1998, 1999; Montenegro et al. 2000, 2001; Muñoz et al, 2001a, b), however, it has not been established yet correlations with the flavonoids present in honey.

According to their botanical origin, honeys may be classified into 3 types: monofloral, bifloral or polyfloral. Monofloral honeys are those where at least 45% and more pollen grains found in it belong to the same species; the bifloral honeys are those where pollens from two species are dominant within the total pollen grains, so that, as a whole, both species cover more than 50% of the total pollen grains, and there is not a difference higher than 5% among them; and finally, polyfloral honeys are those where none of the requirements exposed for monofloral and bifloral honeys are met, this is, those where none specie reaches at least 45% of the total pollen grains, nor two of them covers more than 50% of said total. This patent application considers the use of phenolic extracts obtained from quillay monofloral honeys, which show better stability in their properties between seasons, this is, through time.

In what can be visualized in the previous art it is worth mentioning that it shows the existence of vegetal origin extracts, such as the ones disclosed in the patent applications 2886-2001 and 2377-2004, as well as insecticides and acaricides as agents of the active substances Hederacocid and Alfa-Hederine. Likewise, it is observed the patent application 67-1999 that includes honey in combination with other ingredients useful as cosmetic and sanitary disinfections. However, in none of these publications can be inferred a method as the one proposed nor the product obtained by the same.

Documents covering the same proposed problem can not be found at international level en el object of the invention. Nevertheless, the summary of the Russian patent application RU2236248 from Dec. 27, 2001 and published on Sep. 20, 2004 outstands, which discloses an inmunotropic preparation of medicinal and pharmacological use, in which is provided a honey-based preparation, obtained from feeding bees with a composition that comprises honey obtained from only one flower of the Asteraceae plant family, and which includes specific flavonoids to induce the synthesis of the Alfa and Beta interferon, which present a high effectiveness on the treatment of viral and bacterial prophylaxis. Compositions are described in the Russian applications RU2236247, RU2236244 and RU2241476, however, are not described a method or a product as the ones of the object of this invention.

The results obtained in tests carried out by applying the object of the invention show that the phenolic extracts obtained from quillay (Quillaja saponaria) monofloral honey samples, Chilean endemic species, present a high antioxidant activity. Tests to measure the antioxidant capacity performed with these extracts, using DPPH spectrophotometric technique, have yielded as a result levels of antioxidant activity similar to those of solutions of Trolox® (a powerful antioxidant used in the industry) at concentrations of 0.6 to 1.0 mg/ml. Additionally, the invention proposes a product useful as raw material rich in natural antioxidants, from national and organic origin, to be used in the food and/or pharmaceutical industries.

### DETAILED DESCRIPTION OF THE INVENTION

The invention consists on a concentrated ethanolic extract of phenolic compounds from quillay monofloral honey, endemic vegetal specie of Chile, and the associated production method. There are other species that produce monofloral honeys in the central zone of Chile, where the quillay extends, such as Chilean Wineberry (Aristotelia chilensis), whose phenolic extracts have shown a lower antioxidant capacity. Monofloral honeys from other species, such as corontillo (Escallonia pulverulenta) and tevo (Retanilla trinervia), have been identified, but only in an eventual way and in smaller amounts if compared to quillay honey; reason why the analysis of the antioxidant activity in phenolic extracts from these honeys has not been made yet.

The invention consists on the modification of a method created by the Phytochemistry group CEBAS-CSIC in Murcia, Spain, in order to elaborate an extract of pure phenolic compounds from honey. The technique developed by said group gives as result an extract of total polyphenols in methanol, an alcohol that is toxic for mammals, as it can not be metabolized by the liver. The present invention consists on generating a concentrated ethanolic extract of phenolic compounds from quillay monofloral honey, using basically the same extraction technique, but eliminating the steps where ethylic ether is used, and resuspending the final extract in ethanol, so as to avoid the participation of solvents harmful for human beings (ether and methanol). Ethanol is an alcohol metabolizable by the mammals liver, thus, this new extract might be aggregated directly in food or pharmaceutical products of human consumption. Tests made have demonstrated that, although the antioxidant activity of the ethanolic extract is slightly lower than the activity of the methanolic extract, the differences are not significant, and compared to the activity of other antioxidants used commonly as standards of reference to measure antioxidant capacity, as Trolox®, the ethanolic extract proposed maintains a considerable antioxidant capacity.

To carry out the obtainment of the ethanol extract of phenolic compounds from quillay monofloral honey, and for illustrative purposes only, since a mid-level technician versed in the art can clearly extrapolate the amounts listed below, takes is carried out a process comprising the following stages:
1. Weighing 50 gr of honey in a 100 ml beaker
2. Diluting with 100 ml of distilled water acidified with HCl (pH=2).
3. Placing the solution in a 250 ml volumetric flask, and it is levelled to that volume with acid water.
4. Filtering the solution with cotton and pass it by a column of Amberlita XAD-2 resin (250 mm high per 20 mm of diameter), with a dripping speed of 2 ml/min, where the phenolic compounds are retained in the column.
5. Washing the column with 100 ml of acid water. The liquid is discarded.
6. Washing for a second time with 200 ml of neutral distilled water. The liquid is discarded.
7. Washing for a third time with 300 ml of pure methanol. The methanol will elute the phenolic compounds of the column. The methanol is collected in a clean glass or flask, and transferred to a 500 ml ball flask for rotoevaporator.
8. Concentrating the methanolic solution until it is dried in rotoevaporator, at 45° C. (approx. time: 12 hrs at high rotation speed).
9. Resuspending the residue in 2 ml of 85° ethanol; then, it is ready for analysis or to be used as an antioxidant additive.

To date there has not been formulated or developed any composition that uses the phenolic extract with antioxidant capabilities obtained from quillay honey. However, there have been tests with pilot formulations made with phenolic extract obtained from ulmo honey, which exhibits a lower antioxidant capacity than quillay, but has a greater antibiotic activity, and which is under the Chilean patent application No. 1069-06.

The Chilean application No. 1069-2006 is obtained by an extraction procedure similar to that described above, differing from the resuspension stage of the residue obtained which is performed in water and adds ethyl ether and the present application resuspends the residue in ethanol 85°.

This extract is obtained following the same procedure described earlier, where its biological activity is reserved in aqueous solutions, therefore, we consider that the extract with antioxidant activity obtained from soapbark honey could be also incorporated in other formulations, preserving that activity. It has been proved that the extract preserves its antioxidant activity through time, as it have been performed comparative studies between the activity shown freshly prepared and after a year of storage in freezer (4°-6° C.), which did not show significant differences among them. It has not been elaborated some kind of pilot formulation where it has been proved the conservation of the antioxidant capacity of the extract, but it has been established that it maintains its antibiotic activity (attributed to the same phenolic compounds that give the antioxidant activity to the extract), since a pilot formulation sprayed on vegetables in tests to reduce the development of the decay of vegetable in storage conditions, which include the same type of extract (but obtained from ulmo honey) shows conservation of that property after spending almost one year stored in our laboratory. Therefore, as this property is preserved, it may be assumed that the antibiotic activity will be also preserved, as it depends on the same phenolic compounds. Of course, all this may be proved through the same tests and analysis used for determining the antioxidant capacity of the extract.

### Antioxidant Capacity Determination.

Method: Spectrophotometry with DPPH (1,1-Diphenyl-2-2picrylhydrazyl).
Formula: C₁₈H₁₂N₅O₆.
DPPH molecular weight: 394.3 gr/mol (1 mmol=0.3943 gr=394.3 mg)

### Fundament of the Method:

DPPH is a compound that is considered a free radical, and in solution has a strong violet colour. When it meets an antioxidant compound, stabilizes and loses its colour, so the decrease in absorbance of a DPPH solution by adding an oxidizing compound will indicate the antioxidant capacity of that compound, which will be higher as more and faster is the loss of colour of the DPPH solution.

In order to measure the antioxidant capacity of the honey extract with this method, the following protocol must be followed:
1. Preparing a DPPH solution in methanol, with an absorbance (DO) between 0.6 and 0.7 at 517 nm.
2. Establishing a baseline at 517 nm, doing “auto zero” against a target of methanol.
3. Placing in a glass or quartz tray of 1 ml capacity 950 μl of DPPH solution, and measure its absorbance (this must be between 0.6 and 0.7).
4. Programming the spectrophotometer to measure the absorbance every 5 sec., in order to obtain a kinetic curve.
5. Removing the tray and add 50 μl of the honey extract whose antioxidant capacity needs to be found out.
6. Mixing and returning to the spectrophotometer as fast as possible.
7. Designing an absorbance v/s time graphic, in order to obtain the kinetic curve of the reaction. The reaction is considered finished after 3 min. If the spectrophotometer is not provided with capacity of data storage, each new measure must be recorded. Modern equipments are supplied with an internal memory and screen, where the data can be stored, and the curve may be drawn, respectively.

The decrease in absorbance of the solution (discoloration) indicates stabilization of the DPPH, and the magnitude and speed of this decline will be directly related to the antioxidant capacity of the extract.

### EXAMPLES

Up to date it has been made one test of applicability of the extract in in situ experiments in chicken meat, proving to be effective to extend the shelf life of the chicken meat on trays. Details of the test and analysis of the extract are given below in the section “Trials of Antioxidant Activity of Extracts of Monofloral Honey from Quillay (RM-012 005-M337) on Poultry.”

On the other hand, in conversations with CRAMER S. A., relevant suggestions have been received on the possible use of this extract as an antioxidant additive in foods such as yoghurt, cultivated milk, cookies, sauces, transforming these foods into functional foods. As indicated before, the same type of extract obtained from ulmo honey has been incorporated to pilot formulations, proving that their biological properties are maintained, what makes us think that it can be used as a natural antioxidant to be added in foods or drinks. Examples of products including honey or phenolic extracts as an antioxidant supplement have not been found up to date.

### Trials of Antioxidant Activity of Extracts of Monofloral Honey From Quillay (RM-012 005-M337) on Poultry

The following describes the results of the analysis of the ability to reduce or avoid the oxidation of fat in broiler chickens by a flavonoid extract obtained from a quillay monofloral honey, by the FRAP assay. These results are part of the trials conducted by Professor Maria Angelica Fellenberg, Faculty of Agriculture and Forestry.

This test consists on measuring the antioxidant capacity of a fluid (blood plasma, fruit juice, vegetal extracts or drinks like tea or wine), by the measurement of the content of ferrous ion (Fe⁺³) in the medium. Shortly, in an oxidant environment (which occurs when free radicals or other oxidant agents are present) the Fe⁺³ ion present in the medium will reduce to ferric ion (Fe⁺²). The amount of ion Fe⁺³ that still remains present in the tube or tray where the reaction is made may be evaluated by direct or indirect spectrophotometry (measurement of the absorbance of the solution to a certain wave length). The antioxidant capacity of the sample is expressed in Trolox® equivalents, this is, the amount of Trolox® necessary to show the same antioxidant activity than the sample under evaluation. This compound is a powerful antioxidant, hydrosoluble analogous to Vitamin E, commonly used as a standard, against which the antioxidant activity of the compound or sample analyzed is compared.

The test was carried out testing 3 types of extracts, obtained from a monofloral honey from Quillaja saponaria (quillay), produced in the Río Clarillo sector, commune of Pirque, Metropolitan Region, and harvested in January 2005 (Sample code RM-012005-M337). The methodology to obtain those extracts has been previously described. The composition of phenolic compounds from the extract, result of the analysis via HPLC, shows the presence of the following compounds:

| | Concentration (mg/ml) | |
|---|---|---|
| | of phenolics in extract honey | Retention Time |
| Compound | RM-012005-M337 | (min) |
| Gallic acid | 0.575 | 2.772 |
| Rutin | 0.041 | 6.825 |
| Ferulic acid | 0.046 | 7.427 |
| Salicylic acid | 0.085 | 9.254 |
| Naringenin | 0.069 | 10.359 |
| Kaempherol | 0.036 | 10.843 |

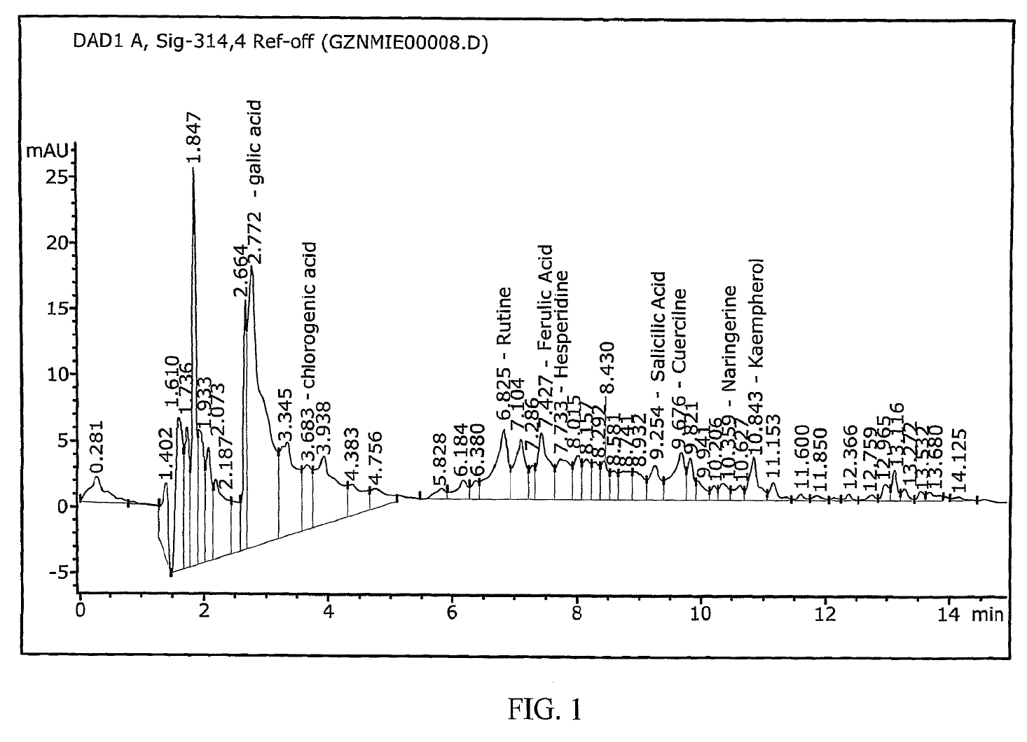

The chromatogram for this extract is showed in FIG. 1. Please note the presence of numerous peaks corresponding to unidentified compounds.

### Results

TABLE 1
Calibration Curve

| mM FeSO₄ | Abs 593 nm | mg/120 mL |
|---|---|---|
| 0 | 0.0925 | 0 |
| 1 | 0.117 | 0.0333624 |
| 5 | 0.232 | 0.166812 |
| 10 | 0.3485 | 0.333624 |
| 15 | 0.469 | 0.500436 |
| 20 | 0.598 | 0.667248 |
| 30 | 0.842 | 1.000872 |

The absorbances exhibited by FeSO₄ solutions in different concentrations are indicated.

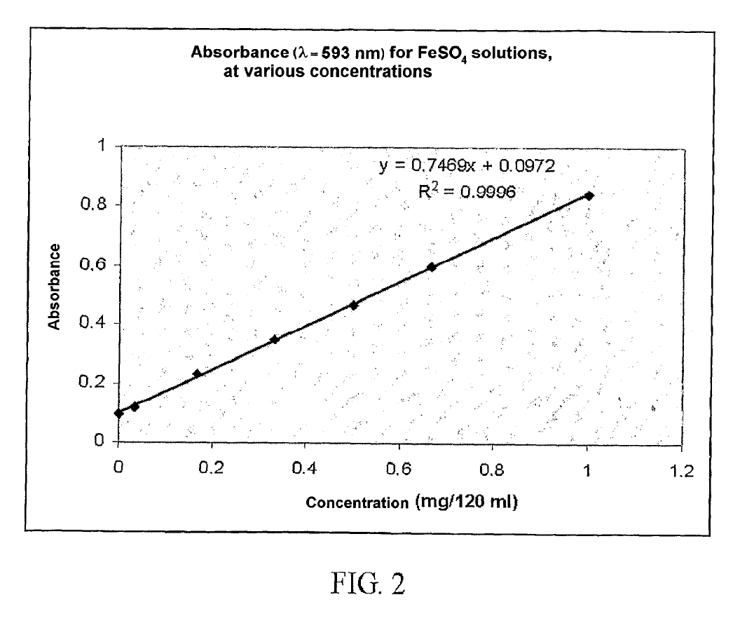

The graphic in FIG. 2 shows the above-indicated values.

These results indicate that the higher the concentration of FeSO4, the greater the absorbance of the solution at 593 nm.

TABLE 2
Antioxidant activity of the extracts, expressed in FeSO₄ equivalents

| Extract | DO 593 nm | Eq. FeSO₄ (ug) |
|---|---|---|
| Methanolic | 0.748 | 0.940546893 |
| Ethanolic 1 | 0.65525 | 0.816694622 |
| Ethanolic 2 | 0.738 | 0.927795848 |

Then, the same procedure was performed, using Trolox®. Therefore, a more direct idea on the antioxidant capacity of the analyzed extracts will be available.

TABLE 3
Calibration Curve

| mM Trolox | DO 593 nm | mg/120 mL |
|---|---|---|
| 0 | 0.16875 | 0 |
| 1 | 0.27875 | 0.0333624 |
| 5 | 0.42525 | 0.166812 |
| 10 | 0.60825 | 0.333624 |
| 15 | 0.7685 | 0.500436 |
| 20 | 0.897 | 0.667248 |

The absorbances exhibited by Trolox ® solutions in different concentrations are indicated

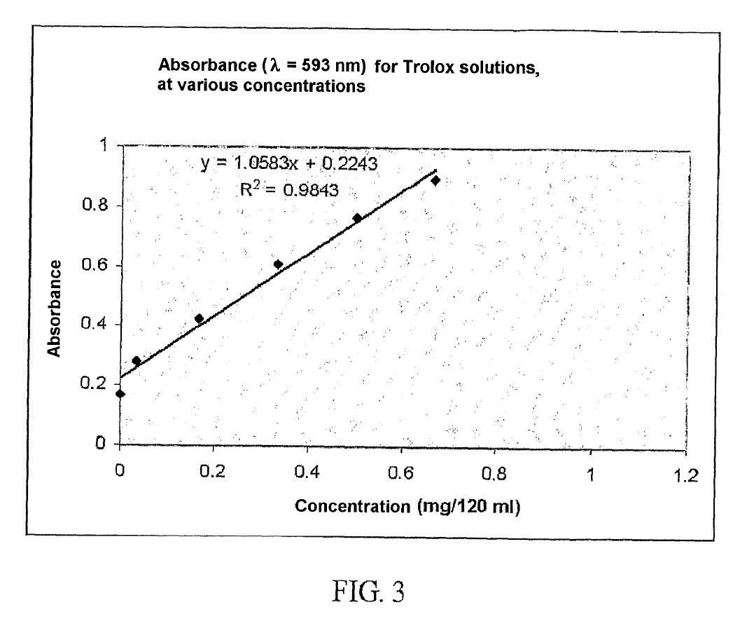

The graphic in FIG. 3 shows the above-indicated values.

As Trolox® is added to the solution, a decrease in absorbance may be observed, which is associated to the capacity for avoiding the reduction of the ion Fe⁺³ to Fe⁺².

TABLE 4
Antioxidant activity of the extracts, expressed in Trolox ® equivalents

| Extract | DO 593 nm | Trolox Eq. (ug) |
|---|---|---|
| Methanolic | 0.7785 | 0.5201918 |
| Ethanolic 1 | 0.6185 | 0.369778451 |
| Ethanolic 2 | 0.6785 | 0.426183457 |

The results of Table 4 indicate that the extract of quillay monofloral honey presenting the highest antioxidant capacity is the ethanolic extract 2, followed, in decreasing order, by the ethanolic extract 1 and the methanolic extract. These results indicate that the extracts from this honey show great potential for diminishing or avoiding oxidation of fats present in poultry for human consumption.

TABLE 5
Equivalence between extract volume from honey and Trolox ®

| Honey Extracts | μL of used | | Equivalence to 1 μg |
|---|---|---|---|
| RM-012005-M337 | extract | μg Trolox ® | of Trolox ® |
| Met | 2.73 | 0.528 | 5.17 |
| Et 1 | 1.5 | 0.364 | 4.12 |
| Et 2 | 1.5 | 0.426 | 3.52 |

Table 5 shows the equivalences between 1 μg (microgram) of Trolox® and the corresponding volume of honey extract, in terms of the antioxidant potential. In other words, 2.73 μl (microliter) of methanolic extract of this honey present the same antioxidant capacity than 1 μg of Trolox®, in the same solution volume.

The extract must be used diluted in the marinate liquid, in the case of poultry, or in a bath, sprinkling or spraying on other types of meat, so that the cut is covered all over with an extract film. The dilution recommended is between 2% and 0.5%, depending on the type of meat where it will be applied (while the percentage of fat in meat is higher, higher the concentration to be used will be, as the lipooxidation or oxidation of fatty acids is avoided or reduced with the extract application. This will also depend on the proportion of unsaturated fat compared to the saturated fat in the tissues, and if the muscle where the cut was obtained is glicolitic or oxidative, therefore, other tests will be required when the application is desired.

### REFERENCES

1. Cabras P., Angioni A., Tuberoso C., Floris I., Reniero F., Guillou C. & Ghelli S. 1999. Homogentisic acid: A phenolic acid as a marker of strawberry-tree (Arbutus unedo) honey. J. Agricultural and Food Chemistry 47(10): 4064-4067.
2. Diplock A. T. 1991. Antioxidant Nutrients and Disease Prevention—An Overview. American J. of Clinical Nutrition 53(1): S189-S193 Suppl.
3. Dugas A. J. Jr., Castañeda-Acosta J., Bonin G. C., Price K. L., Fischer N. H. & Winston G. W. 2000. Evaluation of the total peroxyl radical-scavenging capacity of flavonoids: Structure-activity relationships. J. Natural Products 63(3): 327-331.
4. Fahey J. F. & Stephenson K. K. 2002. Pinostrobin from honey and Thai ginger (Boesenbergia pandurata): A potent flavonoid inducer of mammalian phase 2 chemoprotective and antioxidant enzymes. J. Agricultural and Food Chemistry 50 (25): 7472-7476
5. Ferguson L. R. 2001. Role of plant polyphenolics in genomic stability. Mutation Research—Fundamental and Molecular Mechanisms of Mutagenesis 475(1-2): 89-111 Sp. Iss.
6. Ferreres F., Tomás-Barberán F. A., Gil M. I. & Tomás-Lorente F. 1991. An HPLC technique for flavonoid analysis in honey. J. of the Science of Food and Agriculture 56(1): 49-56.
7. Ferreres F., Garcia-Viguera C., Tomás-Lorente F. & Tomás-Barberán F. A. 1993. Hesperetin—a marker of the floral origin of citrus honey. J. of the Science of Food and Agriculture 61(1): 121-123.
8. Ferreres F., Andrade P., Gil M. I., Tomás-Barberán F. A. 1996. Floral nectar phenolics as biochemical markers for the botanical origin of heather honey. Zeitschrift fur Lebensmittel-Untersuchung und-Forschung 202(1): 40-44.
9. Ferreres F., Juan T., Perez-Arquillue C., Herrera-Marteache A., García Viguera C. & Tomás-Barberán F. A. 1998. Evaluation of pollen as a source of kaempferol in rosemary honey. J. of the Science of Food and Agriculture 77(4): 506-510.
10. Food and Nutrition Board. 1998. Dietary reference intakes: proposed definition and plan for review of dietary antioxidants and related compounds. Institute of Medicine, National Academy of Sciences, National Academy Press, Washington D. C., USA. 24 pp.
11. Gheldof N., Wang X. H. & Engeseth N. J. 2002. Identification and quantification of antioxidant components of honeys from various floral sources. J. Agricultural and Food Chemistry 50: 5870-5877.
12. Ghosh S. & Playford R. 2003. Bioactive natural compounds for the treatment of gastrointestinal disorders. Clinical Science 104: 547-556.
13. Gil M. I., Ferreres F., Ortiz A., Subra E. & Tomás-Barberán F. A. 1995. Plant phenolic metabolites and floral origin of rosemary honey. J. Agricultural and Food Chemistry 43(11): 2833-2838.
14. Ha H. J., Kwon Y. S., Park S. M., Shin T., Park J. H., Kim H. C., Kwon M. S. & Wie M. B. 2003. Quercetin attenuates oxygen-glucose deprivation- and excitotoxin-induced neurotoxicity in primary cortical cell cultures. Biological & Pharmaceutical Bulletin 26(4): 544-546
15. Hertog M. G., Hollman P. C., Kattan M. B. & Kromhout D. 1993a. Intake of potentially anticarcinogenic flavonoids and their determinants in adults in The Netherlands. Nutrition and Cancer 20(1): 21-29.
16. Hertog M. G., Hollman P. C. & Kattan M. B. 1993b. Content of potentially anticarcinogenic flavonoids of tea infusions, wines and fruit juices. J. Agricultural and Food Chemistry 41: 1242-1246.
17. Hughes K. & Ong C. N. 1998. Vitamins, selenium, iron, and coronary heart disease risk in Indians, Malays and Chinese in Singapore. J. Epidemiology and Community Health 52: 181-185.
18. Kahkonen M. P., Hopia A. I. & Heinonen M. 2001. Antioxidant berry phenolics and their antioxidant activity. J. Agricultural and Food Chemistry 49: 4076-4082.
19. Jacob R. A & Burri B. J. 1996. Oxidative damage and defense. American J. of Clinical Nutrition 63: 985S-990S.
20. Jeffrey A. E. & Echazarreta C. M. 1996. Medical uses of honey. Revista Biomedica 7: 43-49.
21. Kinsella J. E., Frankel E., German B. & Kanner J. 1993. Possible mechanisms for the protective role of antioxidants in wine and plant foods. Food Technology 47: 85-89.
22. Lu H. W., Sugahara K., Sagara Y., Masuoka N., Asaka Y., Manabe M. & Kodama H. 2001. Effect of three flavonoids, 5,7,3′,4′-tetrahydroxy-3-methoxy flavone, luteolin, and quercetin, on the stimulus-induced superoxide generation and tyrosyl phosphorylation of proteins in human neutrophil. Archives of Biochemistry and Biophysics 393(1): 73-77.
23. Martos I., Cossentini M., Ferreres F. & Tomás-Barberán F. A. 1997. Flavonoid composition of Tunisian honeys and propolis. J. Agricultural and Food Chemistry 45(8): 2824-2829.
24. Martos I., Ferreres F., Tomás-Barberán F. A. 2000a. Identification of flavonoid markers for the botanical origin of Eucalyptus honey. J. Agricultural and Food Chemistry 48(5): 1498-1502.
25. Martos I., Ferreres F., Yao L. H., D'Arcy B., Caffin N. & Tomás-Barberán F. A. 2000b. Flavonoids in monospecific Eucalyptus honeys from Australia. J. Agricultural and Food Chemistry 48(10): 4744-4748.
26. Middleton E., Kandaswami C & Theoharides T. C. 2000. The effect of plant flavonoids on mammalian cells: implications for inflammation, heart disease and cancer. Pharmacological Review 52: 673-751.
27. Miranda-Rottmann S., Aspillaga A. A., Perez D. D., Vasquez L., Martinez A. L. & Leighton F. 2002. Juice and phenolic fractions of the berry Aristotelia chilensis inhibit LDL oxidation in vitro and protect human endothelial cells against oxidative stress. J. Agricultural and Food Chemistry 50: 7542-7547.
28. Montenegro G. (Ed.). 1992. Flora de interés apícola en Chile. Publicación para ser difundida en el III Encuentro Nacional de Ciencia y Tecnología Apícola, 12 al 14 de Agosto., Chillán, Chile.
29. Montenegro G. 2000. Chile, nuestra flora útil. Ediciones Universidad Católica de Chile, Santiago, Chile. 267 pp.
30. Montenegro G., Timmermann B. N., Pena R. C., Mujica A. M. & Ávila G. 2000. Pollen grains and vegetative structures in propolis as indicators of potential drugs in Chilean plants. Phyton—International J. Experimental Botany 66: 15-23.
31. Montenegro G., Pena R. C., Mujica A. M. & Pizarro R. 2001. Botanical resources for propolis in an apiary network in central Chile. Phyton—International J. Experimental Botany Sp. Iss.: 191-201.
32. Montenegro G., Pizarro R., Ávila G., Castro R., Ríos C., Muñoz O., Bas F. y Gómez M. 2003. Origen botánico y propiedades químicas de las mieles de la Región Mediterránea Árida de Chile. Ciencia e Investigación Agraria 30 (3): 161-174.
33. Montenegro G., Pizarro R., Ávila G., Muñoz O., Mujica A. M. y Bas F. 2005. Determination of the botanical origin and some chemical properties of honeys from the central zone of Chile. Phyton—International J. Experimental Botany Sp. Iss.: 213-223.
34. Muñoz O., Pena R. C., Ureta E., Montenegro G. & Timmermann B. N. 2001a. Propolis from Chilean matorral hives. Zeitschrift fur Naturforschung c—A J. Biosciences 56(3-4): 269-272.
35. Munoz O., Pena R. C., Ureta E., Montenegro G., Caldwell C. & Timmermann B. N. 2001b. Phenolic compounds of propolis from central Chilean matorral. Zeitschrift fur Naturforschung c—A J. Biosciences 56(3-4): 273-277.
36. Pfeffer U., Ferrari N., Morini M., Benelli R., Noonan D. M. & Albini A. 2003. Antiangiogenic activity of chemopreventive drugs. International J. Biological Markers 18(1): 70-74.
37. Pizarro R. y Montenegro G. 2006. Flora Nativa utilizada como fuente de néctar para la elaboración de miel en Chile. XVII Reunión Anual de la Sociedad de Botánica de Chile. Universidad de Talca, Talca, Chile. 19-23 January.
38. Ramirez R. y Monteengro G. 2004. Certificación del origen botánico de miel y polen corbicular pertenecientes a la comuna de Litueche, VI Región de Chile. Ciencia e Investigación Agraria 31(3): 197-211.
39. Reddy A. C. & Lokesh B. R. 1992. Studies on spice principles as antioxidants in the inhibition of lipid peroxidation of rat liver microsomes. Molecular and Cellular Biochemistry 111: 117-124.
40. Russell K., Molan P., Wilkins A. L. & Holland P. T. 1990. Identification of some antibacterial constituents of New Zealand manuka honey. J. Agricultural and Food Chemistry 38: 10-13.
41. Sanchez-Moreno C., Larrauri J. A., Saura-Calixto F. 1991a. Free radical scavenging capacity of selected red, rose and white wines. J. of the Science of Food and Agriculture 79(10): 1301-1304
42. Sanchez-Moreno C., Larrauri J. A., Saura-Calixto F. 1999b. Free radical scavenging capacity and inhibition of lipid oxidation of wines, grape juices and related polyphenolic constituents. Food Research International 32(6): 407-412.
43. Schwarz D. & Roots I. 2003. In vitro assessment of inhibition by natural polyphenols of metabolic activation of procarcinogens by human CYP1A1. Biochemical and Biophysical Research Communications 303 (3): 902-907
44. Simonetti P., Pietta P. & Testolin G. 1997. Polyphenol content and total antioxidant potential of selected italian wines. J. Agricultural and Food Chemistry 45: 1152-1155.
45. Tomás-Barberán F. A., Ferreres F., García-Viguera C. & Tomás-Lorente F. 1993. Flavonoids in honey of different geographical origin. Zeitschrift fur Lebensmittel-Untersuchung und-Forschung 196(1): 38-44
46. Ueda H., Yamazaki C. & Yamazaki M. 2003. Inhibitory effect of perilla leaf extract and luteolin on mouse skin tumor promotion. Biological & Pharmaceutical Bulletin 26(4): 560-563.
47. Valcic S., Montenegro G., Timmermann B. N. 1998. Lignans from Chilean propolis. J. Natural Products 61(6): 771-775.
48. Valcic S, Montenegro G, Mujica A M,. 1999. Phytochemical, morphological, and biological investigations of propolis from Central Chile. Zeitschrift fur Naturforschung c—A J. Biosciences 54(5-6): 406-416.
49. Wandan H. A. L. 1998. Causes of the antimicrobial activity of honey. Infection 26(1): 30-35.
50. Weston R. J., Brocklebank L. K. & Lu Y. 2000. Identification and quantitative levels of antibacterial components of some New Zealand honeys. Food Chemistry 70: 427-435.

1. Natural antioxidant composition for meat products CHARACTERIZED in that it is elaborated from phenolic extracts of monofloral honeys that act independently as antioxidants.

2. Natural antioxidant composition for meat products according to claim 1, CHARACTERIZED in that said monofloral honey is such composed that at least 45% and more of the total pollen grains present correspond to the same vegetal specie.

3. Natural antioxidant composition for meat products according to claim 2, CHARACTERIZED in that said monofloral honey is preferably, but not restricted to quillay honey.

4. Natural antioxidant composition for meat products according to claim 1, CHARACTERIZED in that said extract from monofloral honeys comprises compounds with proven antioxidant activity such as gallic acid, ferulic acid, salicylic acid, rutin, naringenin and kaempherol.

5. Natural antioxidant composition for meat products according to claim 3, CHARACTERIZED in that said honey preferably corresponds to an extract derived from organic quillay monofloral honey, whose composition is the following:

| Compound | Concentration (mg/ml) |
|---|---|
| Gallic acid | 0.575 ± 0.005 mg/ml |
| Rutin | 0.041 ± 0.005 mg/ml |
| Ferulic acid | 0.046 ± 0.005 mg/ml |
| Salicylic acid | 0.085 ± 0.005 mg/ml |
| Naringenin | 0.069 ± 0.005 mg/ml |
| Kaempherol | 0.036 ± 0.005 mg/ml |

with a pH between 4.2 to 5.0

6. Procedure to obtain an extract of monofloral honey useful as antioxidant for meat products CHARACTERIZED in that it comprises the following stages:
1. Weighing the amount of honey to be used;
2. Diluting the honey in distilled water acidified with HCl (pH=2);
3. Placing the solution from the previous stage in a volumetric flask and levelling with acid water;
4. Filtering and passing said solution through a column of cation exchange at a speed of constant dripping, so that the phenolic compounds are retained in said column;
5. Washing said column with acid water and discarding the remaining liquid;
6. Washing said column for a second time with neutral distilled water and discarding the remaining liquid;
7. Washing for a third time with pure methanol to elute the phenolic compounds from the column, then collecting that extract and transfer it to a flask to rotoevaporate;
8. Concentrating the methanolic solution until it is dried in the rotoevaporator, at 45° C.;
9. Resuspending the residue with 85° ethanol, remaining ready to be analyzed or to be used as antioxidant additive.

7. Procedure according to claim 6, CHARACTERIZED in that in stage 4, the filtering process is made through hydrophobic cotton or Watman N° 2 type filter paper, and the column used may be selected from a resin column of cation exchange of Amberlita XAD-2, and the dripping speed may be constantly within the range of 2±0.2 ml per minute.

8. Procedure according to claim 6, CHARACTERIZED in that the resuspending process in stage 9 is carried out with 85° ethanol.

9. Use of a composition elaborated from flavonoid and/or phenols extracts of monofloral honeys, CHARACTERIZED in that it is useful as antioxidant in meat products.

10. Use of a composition elaborated from flavonoid and/or phenols extracts of monofloral honeys according to claim 9, CHARACTERIZED in that it is useful as antioxidant in poultry.

11. Use of a composition elaborated from flavonoid and/or phenols extracts of monofloral honeys according to claim 9 or 10, CHARACTERIZED in that it is useful as antioxidant in chickens.

12. Natural antioxidant composition for meat products according to claim 1, CHARACTERIZED in that it is formulated from a dissolution in the marinate liquid, which allows to present it as a spray product (atomization) or as an antioxidant solution.
